(19) United States
(12) Patent Application Publication
(10) Pub. No.: US 2026/0254092 A1
(43) Pub. Date: Aug. 27, 2026

(54) ANTENNA ASSEMBLY INCLUDING MULTI-LAYER INSULATING STRUCTURE

(71) Applicant: Electronics and Telecommunications Research Institute, Daejeon (KR)

(72) Inventors: Ye-Bon KIM, Daejeon (KR); Euntaek SUNG, Daejeon (KR); Sanguk LEE, Daejeon (KR); Yoola HWANG, Daejeon (KR)

(73) Assignee: Electronics and Telecommunications Research Institute, Daejeon (KR)

(21) Appl. No.: 19/545,221

(22) Filed: Feb. 20, 2026

(30) Foreign Application Priority Data
Feb. 24, 2025 (KR) 10-2025-0023360
Feb. 9, 2026 (KR) 10-2026-0025649

(51) Int. Cl. H01Q 1/00; H01Q 9/04

(52) U.S. Cl. CPC H01Q 1/002; H01Q 9/0414

(57) ABSTRACT

An antenna assembly includes a base plate, a multi-layer insulating structure stacked on an upper side of the base plate and including an opening formed therethrough in a thickness direction thereof, and an antenna disposed on the base plate such that the antenna is positioned inside the opening, wherein the multi-layer insulating structure includes a plurality of stacked dielectric layers and a plurality of stacked conductive layers that are alternately stacked on each other in the thickness direction thereof, and a first peripheral conductive layer disposed to cover an inner circumferential surface of the opening.

### CROSS-REFERENCE TO RELATED APPLICATIONS

This application claims the benefit of Korean Patent Application No. 10-2025-0023360, filed on February 24, 2025, and Korean Patent Application No. 10-2026-0025649, filed on February 9, 2026, in the Korean Intellectual Property Office (now the Ministry of Intellectual Property (MOIP)), the entire disclosures of which are incorporated herein by reference for all purposes.

### BACKGROUND

### 1. FIELD OF THE INVENTION

The following description relates to an antenna assembly including a multi-layer insulating structure.

### 2. DESCRIPTION OF THE RELATED ART

Typically, an antenna is a core component for transmitting and receiving electromagnetic waves in a wireless communication system and has a direct influence on the communication distance, coverage, and system performance. Specifically, in various application environments, such as an aircraft, a satellite, a drone, and a mobile communication device, control of the radiation characteristics of an antenna is required to satisfy communication performance within a limited space. Accordingly, various structural designs and technologies have been studied to increase the beamwidth of an antenna or concentrate radiation in a specific direction. Meanwhile, a multi-layer insulating structure for thermal control or electronic equipment protection may also be applied to the system described above. However, there is a problem that the radiation characteristics may be affected by a change in an electromagnetic environment around the antenna due to a stacked structure of the multi-layer insulating structure.

The above description has been possessed or acquired by the inventor(s) in the course of conceiving the present disclosure and is not necessarily an art publicly known before the present application is filed.

### SUMMARY

An embodiment is to provide an antenna assembly for improving electromagnetic characteristics while maintaining a thermal shielding function.

An embodiment is to provide an antenna assembly for changing radiation characteristics of an antenna by adjusting an arrangement structure and a design parameter of a multi-layer insulating structure.

An embodiment is to provide an antenna assembly in which a beamwidth and/or gain of an antenna is adjusted or a radiation direction of the antenna is tilted.

However, the technical goals are not limited to those described above, and other technical goals may be present.

According to an aspect, there is provided an antenna assembly including a base plate, a multi-layer insulating structure stacked on an upper side of the base plate and including an opening formed therethrough in a thickness direction thereof, and an antenna disposed on the base plate such that the antenna is positioned inside the opening, wherein the multi-layer insulating structure includes a plurality of stacked dielectric layers and a plurality of stacked conductive layers that are alternately stacked on each other in the thickness direction thereof, and a first peripheral conductive layer disposed to cover an inner circumferential surface of the opening.

The plurality of stacked dielectric layers includes a first stacked dielectric layer disposed on the upper side of the base plate, and a second stacked dielectric layer disposed on an upper side of the first stacked dielectric layer, wherein the plurality of stacked conductive layers includes a first stacked conductive layer disposed between the first stacked dielectric layer and the second stacked dielectric layer, and a second stacked conductive layer disposed on an upper side of the second stacked dielectric layer.

The second stacked dielectric layer is exposed to the upper side between the first peripheral conductive layer and the second stacked conductive layer.

A cross-sectional area of the opening is formed to decrease toward the base plate.

Based on a cross-section in the thickness direction thereof, the inner circumferential surface of the opening is inclined outward from the base plate toward the upper side.

Based on the cross-section in the thickness direction thereof, an angle formed by the inner circumferential surface of the opening and the base plate is constant in a circumferential direction of the opening.

A width of a part of the second stacked dielectric layer exposed to the upper side between the first peripheral conductive layer and the second stacked conductive layer is constant in a circumferential direction of the antenna.

An edge of each of the plurality of stacked conductive layers facing the opening is spaced apart from the first peripheral conductive layer.

When viewed in the thickness direction thereof, an edge of the second stacked conductive layer facing the opening coincides with an edge of the first stacked conductive layer facing the opening.

When viewed in the thickness direction thereof, an edge of the second stacked conductive layer facing the opening further extends in a direction facing the opening compared to an edge of the first stacked conductive layer facing the opening.

A permittivity of the second stacked dielectric layer is greater than a permittivity of the first stacked dielectric layer.

When viewed in the thickness direction thereof, the opening has a regular polygonal shape.

A thickness of the second stacked dielectric layer is less than a thickness of the first stacked dielectric layer.

Based on a cross-section in the thickness direction thereof, a gap between the antenna and the first peripheral conductive layer is constant in a circumferential direction of the opening.

The multi-layer insulating structure further includes a second peripheral conductive layer disposed on an upper side of a stacked dielectric layer positioned at a top of the plurality of stacked dielectric layers.

According to an aspect, there is provided an antenna assembly including a base plate, a multi-layer insulating structure stacked on an upper side of the base plate and including an opening formed therethrough in a thickness direction thereof, and an antenna disposed on the base plate such that the antenna is positioned inside the opening, wherein the multi-layer insulating structure includes a first stacked dielectric layer disposed on the upper side of the base plate, a second stacked dielectric layer disposed on an upper side of the first stacked dielectric layer, a first stacked conductive layer disposed between the first stacked dielectric layer and the second stacked dielectric layer, a second stacked conductive layer disposed on an upper side of the second stacked dielectric layer, a first peripheral conductive layer disposed along an entirety of an inner circumferential surface of the opening, and a second peripheral conductive layer disposed on an upper side of the second stacked dielectric layer and connected to the first peripheral conductive layer.

The second stacked dielectric layer is exposed to the upper side between the second peripheral conductive layer and the second stacked conductive layer.

A width of a part of the second stacked dielectric layer exposed to the upper side between the second peripheral conductive layer and the second stacked conductive layer is constant in a circumferential direction of the antenna.

A width of a part of the second stacked dielectric layer exposed to the upper side between the second peripheral conductive layer and the second stacked conductive layer is between 0.10 times and 0.22 times a free space wavelength of the antenna.

According to an aspect, there is provided an antenna assembly including a base plate, a multi-layer insulating structure stacked on an upper side of the base plate and including an opening formed therethrough in a thickness direction thereof, and an antenna disposed on the base plate such that the antenna is positioned inside the opening, wherein the multi-layer insulating structure includes a plurality of stacked dielectric layers and a plurality of stacked conductive layers that are alternately arranged, and a first peripheral conductive layer disposed along at least a portion of an inner circumferential surface of the opening, wherein the multi-layer insulating structure is configured to tilt a radiation direction of the antenna.

Additional aspects of embodiments will be set forth in part in the description which follows and, in part, will be apparent from the description, or may be learned by practice of the disclosure.

An antenna assembly according to an embodiment may improve electromagnetic characteristics while maintaining a thermal shielding function.

An antenna assembly according to an embodiment may change radiation characteristics of an antenna by adjusting an arrangement structure and a design parameter of a multi-layer insulating structure.

In an antenna assembly according to an embodiment, a beamwidth and/or gain of an antenna may be adjusted or a radiation direction of the antenna may be tilted.

The effects of the antenna assembly according to embodiments are not limited to the above-mentioned effects, and other unmentioned effects can be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1A is a perspective view of an antenna assembly according to an embodiment;

FIG. 1B is a cross-sectional view of an antenna assembly according to an embodiment;

FIG. 2A is a perspective view of an antenna assembly according to an embodiment;

FIG. 2B is a cross-sectional view of an antenna assembly according to an embodiment; and

FIGS. 3A to 3D are plan views of an antenna assembly according to an embodiment and conceptually illustrate a radiation pattern shape of an antenna.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms of "first," "second," and the like are used to explain various components, the components are not limited to such terms. These terms are used only to distinguish one component from another component. For example, a first component may be referred to as a second component, or similarly, the second component may be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

As used herein, the singular forms "a," "an," and "the" are intended to include the plural forms as well, unless the context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. It will be understood that the terms "comprises/comprising" and/or "includes/including" when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments are described in detail with reference to the accompanying drawings. When describing the embodiments with reference to the accompanying drawings, like reference numerals refer to like components and a repeated description related thereto will be omitted.

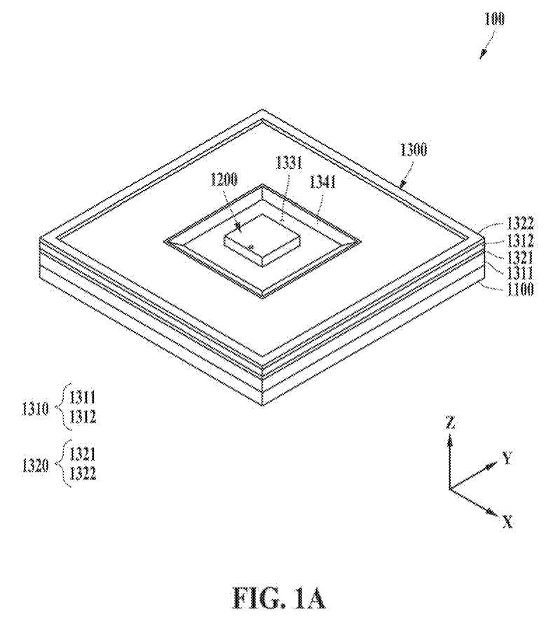

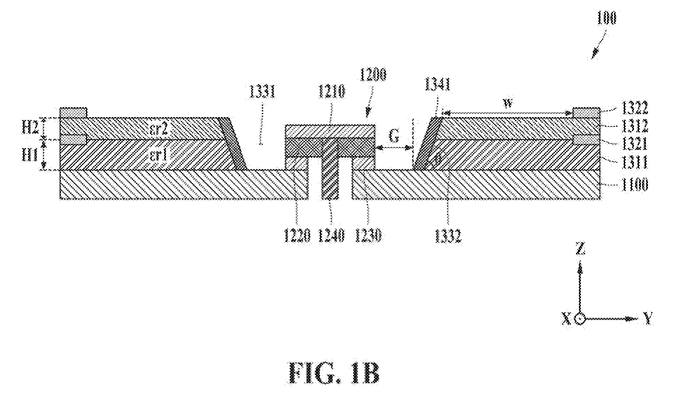

FIG. 1A is a perspective view of an antenna assembly according to an embodiment. FIG. 1B is a cross-sectional view of an antenna assembly according to an embodiment.

Referring to FIGS. 1A and 1B, an antenna assembly 100 according to an embodiment may include a base plate 1100, an antenna 1200, and a multi-layer insulating structure (or also referred to as multi-layer insulation (MLI)) 1300. The base plate 1100 may be a support structure on which the antenna 1200 and/or the MLI 1300 are disposed. For example, the base plate 1100 may be a plate disposed inside or outside of electronic equipment applied to a space environment, an aircraft, a drone, or high-frequency communication equipment. The antenna 1200 may be disposed on the base plate 1100 and may be a radiating device for transmitting and/or receiving a wireless signal. The MLI 1300 may be stacked on an upper side (e.g., the side in the +Z direction) of the base plate 1100. The MLI 1300 may be disposed around the antenna 1200 to affect the electromagnetic characteristics of the antenna 1200. The MLI 1300 may have a structure in which a plurality of stacked dielectric layers 1310 and a plurality of stacked conductive layers 1320 are alternately stacked. The MLI 1300 may simultaneously perform a thermal shielding function and an electromagnetic function. In this case, the "upper side" may refer to a side in the +Z direction, and the "lower side" may refer to a side in the -Z direction.

In an embodiment, the base plate 1100 may support the antenna 1200 and/or the MLI 1300. For example, the antenna 1200 and/or the MLI 1300 may be disposed on the upper side (e.g., the side in the +Z direction) of the base plate 1100. Although only a portion of the base plate 1100 is illustrated in FIGS. 1A and 1B, it may be construed that the base plate 1100 extends on the XY plane.

In an embodiment, the antenna 1200 may be disposed on the base plate 1100. For example, the antenna 1200 may be disposed on the upper side (e.g., the side in the +Z direction) of the base plate 1100. The antenna 1200 may be electrically connected to an active device (not illustrated) disposed on the base plate 1100. The active device may include, for example, an amplifier, a wireless transceiver circuit, and/or a phase shifter. The active device may be configured to control the characteristics of a signal applied to the antenna 1200. For example, the antenna 1200 may be a single antenna or an array of antennas. For example, the antenna 1200 may be one of a patch antenna, a slot antenna, and a dipole antenna.

In an embodiment, the electromagnetic characteristics of the antenna 1200 may vary depending on an electromagnetic environment formed by the MLI 1300. For example, the MLI 1300 may be disposed to increase the beamwidth of the antenna 1200.

In an embodiment, the antenna 1200 may include a patch 1210, a dielectric region 1220, ground 1230, and/or a feeder 1240. The patch 1210 and the ground 1230 may be formed on different surfaces based on the dielectric region 1220. For example, the patch 1210 may be positioned on the upper side (e.g., the side in the +Z direction) of the dielectric region 1220. For example, the ground 1230 may be positioned on the lower side (e.g., the side in the -Z direction) of the dielectric region 1220. The feeder 1240 may be electrically connected to the patch 1210 to apply a signal to the antenna 1200. For example, the feeder 1240 may be implemented as one of a microstrip line, a coaxial feeder, or a probe feeder. FIGS. 1A and 1B illustrate that the patch 1210 has a rectangular shape, but the shape of the patch 1210 is not limited thereto.

In an embodiment, the MLI 1300 may be stacked on the base plate 1100. For example, the MLI 1300 may be stacked on the upper side (e.g., the side in the +Z direction) of the base plate 1100. The MLI 1300 may be configured to change the electromagnetic characteristics of the antenna 1200.

In an embodiment, the MLI 1300 may include the plurality of stacked dielectric layers 1310 and the plurality of stacked conductive layers 1320 that are alternately stacked on each other in the thickness direction (e.g., the Z-axis direction) of the MLI 1300. For example, each of the plurality of stacked dielectric layers 1310 may include an insulating material, such as polyester or Teflon. For example, each of the plurality of stacked conductive layers 1320 may include an electrically conductive material or metal alloy, such as aluminum (Al) or silver (Ag). The plurality of stacked dielectric layers 1310 may include a first stacked dielectric layer 1311 and a second stacked dielectric layer 1312. The plurality of stacked conductive layers 1320 may include a first stacked conductive layer 1321 and a second stacked conductive layer 1322. The first stacked dielectric layer 1311 may be disposed on the upper side (e.g., the side in the +Z direction) of the base plate 1100. The second stacked dielectric layer 1312 may be disposed on the upper side (e.g., the side in the +Z direction) of the first stacked dielectric layer 1311. The first stacked conductive layer 1321 may be disposed between the first stacked dielectric layer 1311 and the second stacked dielectric layer 1312. The second stacked conductive layer 1322 may be disposed on the upper side (e.g., the side in the +Z direction) of the second stacked dielectric layer 1312. In other words, the first stacked dielectric layer 1311, the first stacked conductive layer 1321, the second stacked dielectric layer 1312, and the second stacked conductive layer 1322 may be sequentially disposed on the upper side (e.g., the side in the +Z direction) of the base plate 1100. Although FIGS. 1A and 1B illustrate that the MLI 1300 includes two stacked dielectric layers (i.e., 1311 and 1312) and two stacked conductive layers (i.e., 1321 and 1322), this is an example, and the numbers and/or arrangement orders of the stacked dielectric layers and the stacked conductive layers are not limited thereto. For example, the MLI 1300 may include three stacked dielectric layers and three stacked conductive layers that are alternately stacked on each other in the thickness direction (e.g., the Z-axis direction) of the MLI 1300. In this case, a stacked dielectric layer positioned at the top among the plurality of stacked dielectric layers 1310 may be referred to as the second stacked dielectric layer 1312, a stacked dielectric layer positioned on the lower side (e.g., the side in the -Z direction) of the second stacked dielectric layer 1312 may be referred to as the first stacked dielectric layer 1311, a stacked conductive layer positioned on the upper side (e.g., the side in the +Z direction) of the second stacked dielectric layer 1312 may be referred to as the second stacked conductive layer 1322, and a stacked conductive layer positioned between the second stacked dielectric layer 1312 and the first stacked dielectric layer 1311 may be referred to as the first stacked conductive layer 1321.

In an embodiment, a thickness H2 of the second stacked dielectric layer 1312 may be less than a thickness H1 of the first stacked dielectric layer 1311. Due to the difference in thickness, a distribution of an electromagnetic field and a path of electromagnetic wave propagation radiated by the antenna 1200 may vary. Specifically, the second stacked dielectric layer 1312 that is relatively thin may cause the electromagnetic field to be easily diffused to the outside of the antenna assembly 100. Accordingly, as a radiation angle increases, the beamwidth may increase.

In an embodiment, the first stacked conductive layer 1321 and the second stacked conductive layer 1322 may not be electrically connected to each other. In other words, the first stacked conductive layer 1321 and the second stacked conductive layer 1322 may be electrically insulated by the second stacked dielectric layer 1312.

In an embodiment, an opening 1331 may be formed through the MLI 1300 in the thickness direction (e.g., the Z-axis direction) of the MLI 1300. The cross-sectional area of the opening 1331 may be formed to decrease toward the base plate 1100. In other words, the cross-sectional area of the opening 1331 may be formed to decrease toward the lower side (e.g., the side in the -Z direction) of the antenna assembly 100. Based on the cross-section in the thickness direction (e.g., the Z-axis direction) of the MLI 1300, an inner circumferential surface 1332 of the opening 1331 may be inclined outward from the base plate 1100 toward the upper side (e.g., the side in the +Z direction) of the antenna assembly 100. Based on the cross-section in the thickness direction (e.g., the Z-axis direction) of the MLI 1300, an angle θ formed by the inner circumferential surface 1332 of the opening 1331 and the base plate 1100 may be substantially constant in the circumferential direction of the opening 1331. The opening 1331 may have a circular or polygonal shape. For example, the opening 1331 may have a regular polygonal shape. In this case, the "opening" may refer to a space formed inside the MLI 1300. The "inner circumferential surface" of the opening 1331 may refer to the surface of the MLI 1300 that forms the opening 1331. The "shape of the opening" may refer to the shape of the opening 1331 viewed in the Z-axis direction.

In an embodiment, the antenna 1200 may be disposed on the base plate 1100. For example, the antenna 1200 may be disposed on the upper side (e.g., the side in the +Z direction) of the base plate 1100 such that the antenna 1200 is positioned inside the opening 1331. The inner circumferential surface 1332 of the opening 1331 may be disposed symmetrically around the antenna 1200. For example, the antenna 1200 may be disposed inside the opening 1331 such that the center of the opening 1331 coincides with the center of the antenna 1200. In this case, the "inside" may refer to a direction toward the center of the opening 1331, and the "outside" may refer to a direction away from the center of the opening 1331.

In an embodiment, the antenna 1200 may be spaced apart from a first peripheral conductive layer 1341. For example, based on a surface on which the first peripheral conductive layer 1341 is in contact with the base plate 1100, the antenna 1200 may be spaced apart from the first peripheral conductive layer 1341 by a predetermined gap G. In other words, based on a cross-section in the thickness direction (e.g., the Z-axis direction) of the MLI 1300, a gap between the antenna 1200 and the first peripheral conductive layer 1341 may be substantially constant in the circumferential direction of the opening 1331.

In an embodiment, the MLI 1300 may further include the first peripheral conductive layer 1341. The first peripheral conductive layer 1341 may be disposed to cover the inner circumferential surface 1332 of the opening 1331. For example, the first peripheral conductive layer 1341 may be disposed along the entire inner circumferential surface 1332 of the opening 1331. As the first peripheral conductive layer 1341 is disposed along the entire inner circumferential surface 1332 of the opening 1331, the plurality of stacked dielectric layers 1310 and the plurality of stacked conductive layers 1320 may not be exposed on the inner circumferential surface 1332 of the opening 1331. The first peripheral conductive layer 1341 may include a material that is the same as or different from the first stacked conductive layer 1321 and the second stacked conductive layer 1322. The first peripheral conductive layer 1341 may form or control a radiation pattern by reflecting electromagnetic waves radiated from the antenna 1200.

In an embodiment, the second stacked dielectric layer 1312 may be exposed to the upper side (e.g., the side in the +Z direction) between the first peripheral conductive layer 1341 and the second stacked conductive layer 1322. In this case, a width W of a part of the second stacked dielectric layer 1312 exposed to the upper side (e.g., the side in the +Z direction) between the first peripheral conductive layer 1341 and the second stacked conductive layer 1322 may be constant in the circumferential direction of the antenna 1200.

In an embodiment, an edge of each of the plurality of stacked conductive layers 1320 facing the opening 1331 may be spaced apart from the first peripheral conductive layer 1341. For example, the first stacked conductive layer 1321 and the second stacked conductive layer 1322 may be spaced apart from the first peripheral conductive layer 1341. In other words, the first stacked conductive layer 1321 may not extend to the inner circumferential surface 1332 of the opening 1331, and the second stacked conductive layer 1322 may not extend to the inner circumferential surface 1332 of the opening 1331.

In an embodiment, when viewed in the thickness direction (e.g., the Z-axis direction) of the MLI 1300, an edge of the second stacked conductive layer 1322 facing the opening 1331 may coincide with an edge of the first stacked conductive layer 1321 facing the opening 1331. Alternatively, when viewed in the thickness direction (e.g., the Z-axis direction) of the MLI 1300, the edge of the second stacked conductive layer 1322 facing the opening 1331 may further extend in a direction facing the opening 1331 compared to the edge of the first stacked conductive layer 1321 facing the opening 1331. By the structure described above, a thermal shielding function by the MLI 1300 may be maintained while minimizing the influence of the first stacked conductive layer 1321 on the radiation characteristics of the antenna 1200.

In an embodiment, the refraction and reflection characteristics of an electromagnetic field may vary depending on a ratio εᵣ₂/εᵣ₁ of a permittivity εᵣ₂ of the second stacked dielectric layer 1312 to a permittivity εᵣ₁ of the first stacked dielectric layer 1311. For example, the permittivity εᵣ₂ of the second stacked dielectric layer 1312 may be greater than the permittivity εᵣ₁ of the first stacked dielectric layer 1311. The distribution of the electromagnetic field may be changed by the difference in permittivity between the second stacked dielectric layer 1312 and the first stacked dielectric layer 1311. By the structure described above, the radiation beamwidth of the antenna 1200 may increase. For example, as the ratio εᵣ₂/εᵣ₁ of the permittivity εᵣ₂ of the second stacked dielectric layer 1312 to the permittivity εᵣ₁ of the first stacked dielectric layer 1311 increases, the radiation beamwidth of the antenna 1200 may increase. The ratio of permittivity may be set within a range that may change the radiation characteristics of the antenna 1200.

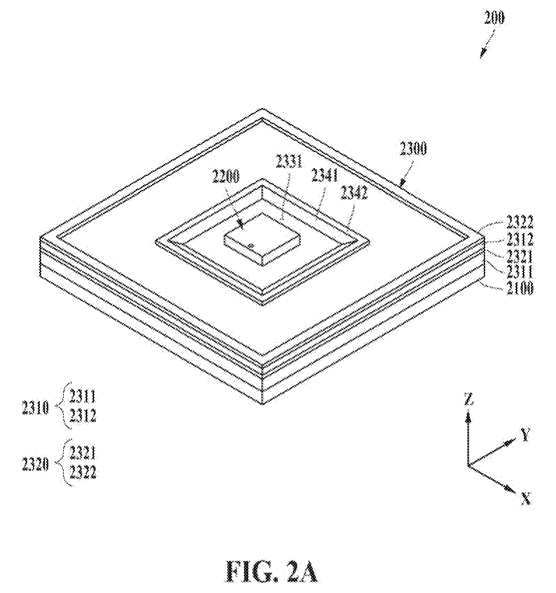

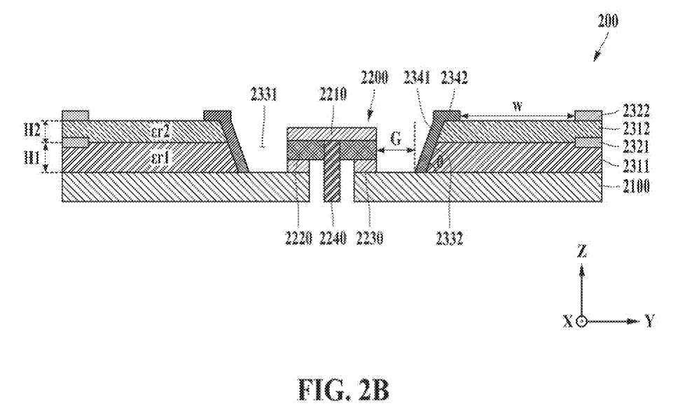

FIG. 2A is a perspective view of an antenna assembly according to an embodiment. FIG. 2B is a cross-sectional view of an antenna assembly according to an embodiment.

Referring to FIGS. 2A and 2B, an antenna assembly 200 according to an embodiment may include a base plate 2100, an antenna 2200, and an MLI 2300. In describing the antenna assembly 200 of FIGS. 2A and 2B, unless otherwise disclosed, the description of the antenna assembly 100 provided with reference to FIGS. 1A and 1B applies to the antenna assembly 200 to the extent in which the descriptions do not conflict with each other.

In an embodiment, the electromagnetic characteristics of the antenna 2200 may vary depending on an electromagnetic environment formed by the MLI 2300. For example, the MLI 2300 may be disposed to increase the gain of the antenna 2200.

In an embodiment, the MLI 2300 may include a first peripheral conductive layer 2341 and a second peripheral conductive layer 2342. The first peripheral conductive layer 2341 may be disposed along the entirety of an inner circumferential surface 2332 of an opening 2331. The second peripheral conductive layer 2342 may be disposed on an upper side (e.g., the side in the +Z direction) of a stacked dielectric layer positioned on the top among a plurality of stacked dielectric layers 2310. The second peripheral conductive layer 2342 may be disposed on the upper side of a second stacked dielectric layer 2312 and may be connected to the first peripheral conductive layer 2341. The second peripheral conductive layer 2342 and a second stacked conductive layer 2322 may be positioned on the same plane (coplanar).

In an embodiment, the second stacked dielectric layer 2312 may be exposed to the upper side (e.g., the side in the +Z direction) between the second peripheral conductive layer 2342 and the second stacked conductive layer 2322. In this case, a width W of a part of the second stacked dielectric layer 2312 exposed to the upper side (e.g., the side in the +Z direction) between the second peripheral conductive layer 2342 and the second stacked conductive layer 2322 may be constant in the circumferential direction of the antenna 2200. In FIGS. 2A and 2B, the first peripheral conductive layer 2341 and the second peripheral conductive layer 2342 are integrally formed; however, the configuration of the first peripheral conductive layer 2341 and the second peripheral conductive layer 2342 is not limited thereto. For example, the first peripheral conductive layer 2341 and the second peripheral conductive layer 2342 may be separately formed and may be connected to each other. By the structure described above, as the area in which electromagnetic waves are reflected increases, the gain of the antenna 2200 may increase.

In an embodiment, the width W of the part of the second stacked dielectric layer 2312 exposed to the upper side (e.g., the side in the +Z direction) between the second peripheral conductive layer 2342 and the second stacked conductive layer 2322 may be between about 0.10 times and about 0.30 times, between about 0.10 times and 0.25 times, or preferably between about 0.10 times and about 0.22 times a free space wavelength λ₀ of the antenna 2200. Accordingly, a distribution of the reflected electromagnetic field formed by the MLI 2300 may be controlled, thereby adjusting the electromagnetic characteristics of the antenna 2200.

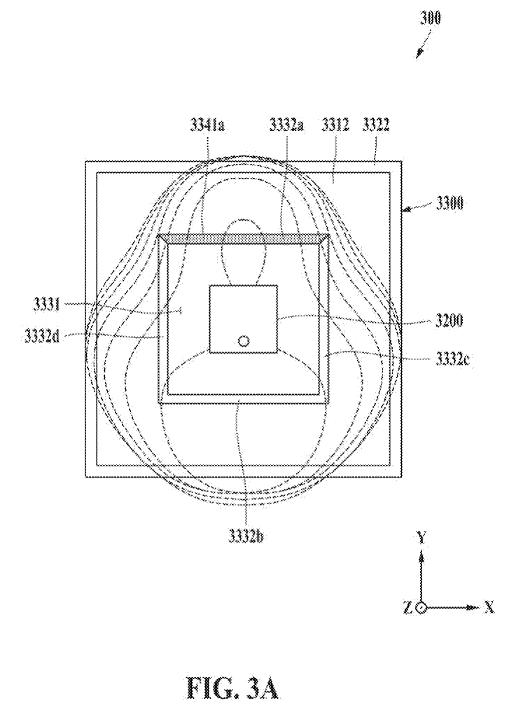

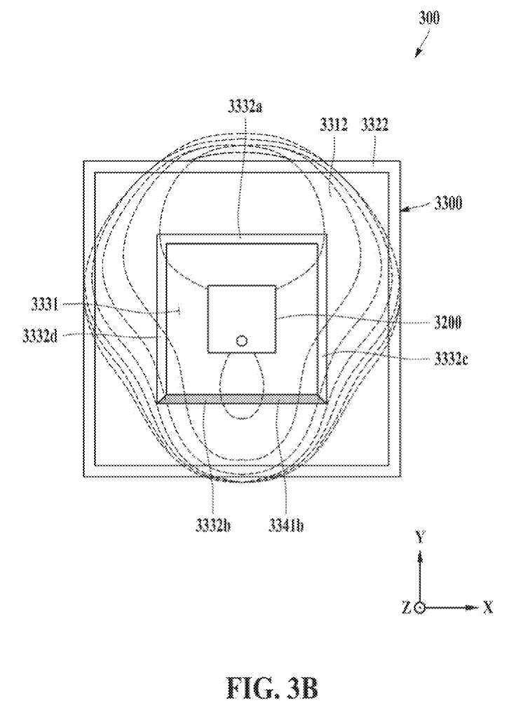

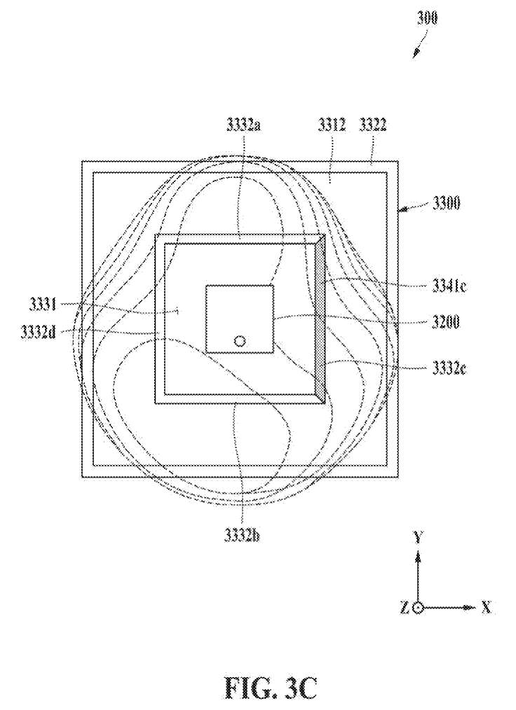

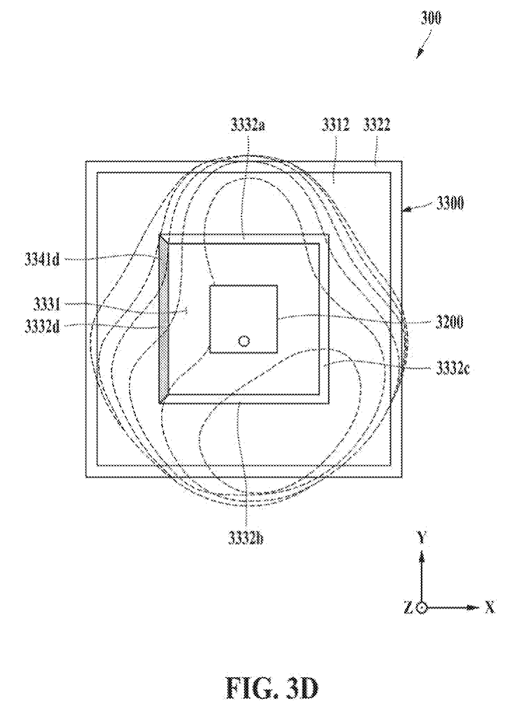

FIGS. 3A to 3D are plan views of an antenna assembly according to an embodiment and conceptually illustrate a radiation pattern shape of an antenna.

Referring to FIGS. 3A to 3D, an antenna assembly 300 according to an embodiment may include a base plate, an antenna 3200, and an MLI 3300. In describing the antenna assembly 300 of FIGS. 3A to 3D, unless otherwise disclosed, the description of the antenna assembly 100 provided with reference to FIGS. 1A and 1B applies to the antenna assembly 300 to the extent in which the descriptions do not conflict with each other.

In an embodiment, first peripheral conductive layers 3341a, 3341b, 3341c, and 3341d may be disposed along at least a portion of inner circumferential surfaces 3332a, 3332b, 3332c, and 3332d of an opening 3331. For example, the first peripheral conductive layer 3341a may be disposed on the inner circumferential surface 3332a of the opening 3331 in the +Y direction (e.g., refer to FIG. 3A). For example, the first peripheral conductive layer 3341b may be disposed on the inner circumferential surface 3332b of the opening 3331 in the -Y direction (e.g., refer to FIG. 3B). For example, the first peripheral conductive layer 3341c may be disposed on the inner circumferential surface 3332c of the opening 3331 in the +X direction (e.g., refer to FIG. 3C). For example, the first peripheral conductive layer 3341d may be disposed on the inner circumferential surface 3332d of the opening 3331 in the -X direction (e.g., refer to FIG. 3D). However, the arrangements of the first peripheral conductive layers 3341a, 3341b, 3341c, and 3341d and/or the shape of the opening 3331 are not limited to FIGS. 3A to 3D. For example, a first peripheral conductive layer may be disposed on an inner circumferential surface of an opening in the +X direction and an inner circumferential surface of an opening in the +Y direction.

In an embodiment, the MLI 3300 may be configured to change the electromagnetic characteristics of the antenna 3200. The first peripheral conductive layers 3341a, 3341b, 3341c, and 3341d of the MLI 3300 disposed along at least a portion of the inner circumferential surfaces 3332a, 3332b, 3332c, and 3332d of the opening 3331 may change the radiation pattern of the antenna 3200. For example, the first peripheral conductive layers 3341a, 3341b, 3341c, and 3341d may be configured to tilt a radiation direction of the antenna 3200 by changing a phase distribution of the electromagnetic field. FIGS. 3A to 3D illustrate changes in a radiation pattern shape of the antenna 3200 according to the arrangements of the first peripheral conductive layers 3341a, 3341b, 3341c, and 3341d with dashed lines.

Referring to FIGS. 1A to 3D, in the antenna assemblies 100, 200, and 300 according to an embodiment, the electromagnetic characteristics of the antennas 1200, 2200, and 3200 may be differently formed according to the shapes of the openings 1331, 2331, and 3331 of the MLIs 1300, 2300, and 3300, the thickness of each of the plurality of stacked dielectric layers (i.e., 1310 and 2310) and the thickness of each of the plurality of stacked conductive layers (i.e., 1320 and 2320), the permittivity ratio of the plurality of stacked dielectric layers (i.e., 1310 and 2310), and/or the arrangements of the second peripheral conductive layer 3342 and the first peripheral conductive layers 1341, 2341, 3341a, 3341b, 3341c, and 3341d. Accordingly, the radiation characteristics of the antennas 1200, 2200, and 3200 may be changed to meet a required communication environment by changing arrangement structures and/or design parameters of the MLIs 1300, 2300, and 3300, even if the same antenna structure is used.

In addition, in FIGS. 1A to 3D, the antenna assemblies 100, 200, and 300 are independently illustrated. However, this is for ease of description, and the configurations described with reference to FIGS. 1A to 3D may be combined with each other. In other words, increasing the beamwidth, increasing the gain, and tilting the radiation direction are not mutually exclusive effects and may be implemented individually or in combination depending on the design objective.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the following claims.

What is claimed is:

1. An antenna assembly comprising: a base plate; a multi-layer insulating structure stacked on an upper side of the base plate and comprising an opening formed therethrough in a thickness direction thereof; and an antenna disposed on the base plate such that the antenna is positioned inside the opening, wherein the multi-layer insulating structure comprises: a plurality of stacked dielectric layers and a plurality of stacked conductive layers that are alternately stacked on each other in the thickness direction thereof; and a first peripheral conductive layer disposed to cover an inner circumferential surface of the opening.

2. The antenna assembly of claim 1, wherein the plurality of stacked dielectric layers comprises: a first stacked dielectric layer disposed on the upper side of the base plate; and a second stacked dielectric layer disposed on an upper side of the first stacked dielectric layer, wherein the plurality of stacked conductive layers comprises: a first stacked conductive layer disposed between the first stacked dielectric layer and the second stacked dielectric layer; and a second stacked conductive layer disposed on an upper side of the second stacked dielectric layer.

3. The antenna assembly of claim 2, wherein the second stacked dielectric layer is exposed to the upper side between the first peripheral conductive layer and the second stacked conductive layer.

4. The antenna assembly of claim 1, wherein a cross-sectional area of the opening is formed to decrease toward the base plate.

5. The antenna assembly of claim 4, wherein, based on a cross-section in the thickness direction thereof, the inner circumferential surface of the opening is inclined outward from the base plate toward the upper side.

6. The antenna assembly of claim 5, wherein, based on the cross-section in the thickness direction thereof, an angle formed by the inner circumferential surface of the opening and the base plate is constant in a circumferential direction of the opening.

7. The antenna assembly of claim 3, wherein a width of a part of the second stacked dielectric layer exposed to the upper side between the first peripheral conductive layer and the second stacked conductive layer is constant in a circumferential direction of the antenna.

8. The antenna assembly of claim 1, wherein an edge of each of the plurality of stacked conductive layers facing the opening is spaced apart from the first peripheral conductive layer.

9. The antenna assembly of claim 2, wherein, when viewed in the thickness direction thereof, an edge of the second stacked conductive layer facing the opening coincides with an edge of the first stacked conductive layer facing the opening.

10. The antenna assembly of claim 2, wherein, when viewed in the thickness direction thereof, an edge of the second stacked conductive layer facing the opening further extends in a direction facing the opening compared to an edge of the first stacked conductive layer facing the opening.

11. The antenna assembly of claim 2, wherein a permittivity of the second stacked dielectric layer is greater than a permittivity of the first stacked dielectric layer.

12. The antenna assembly of claim 4, wherein, when viewed in the thickness direction thereof, the opening has a regular polygonal shape.

13. The antenna assembly of claim 2, wherein a thickness of the second stacked dielectric layer is less than a thickness of the first stacked dielectric layer.

14. The antenna assembly of claim 2, wherein, based on a cross-section in the thickness direction thereof, a gap between the antenna and the first peripheral conductive layer is constant in a circumferential direction of the opening.

15. The antenna assembly of claim 1, wherein the multi-layer insulating structure further comprises a second peripheral conductive layer disposed on an upper side of a stacked dielectric layer positioned at a top of the plurality of stacked dielectric layers.

16. An antenna assembly comprising: a base plate; a multi-layer insulating structure stacked on an upper side of the base plate and comprising an opening formed therethrough in a thickness direction thereof; and an antenna disposed on the base plate such that the antenna is positioned inside the opening, wherein the multi-layer insulating structure comprises: a first stacked dielectric layer disposed on the upper side of the base plate; a second stacked dielectric layer disposed on an upper side of the first stacked dielectric layer; a first stacked conductive layer disposed between the first stacked dielectric layer and the second stacked dielectric layer; a second stacked conductive layer disposed on an upper side of the second stacked dielectric layer; a first peripheral conductive layer disposed along an entirety of an inner circumferential surface of the opening; and a second peripheral conductive layer disposed on an upper side of the second stacked dielectric layer and connected to the first peripheral conductive layer.

17. The antenna assembly of claim 16, wherein the second stacked dielectric layer is exposed to the upper side between the second peripheral conductive layer and the second stacked conductive layer.

18. The antenna assembly of claim 17, wherein a width of a part of the second stacked dielectric layer exposed to the upper side between the second peripheral conductive layer and the second stacked conductive layer is constant in a circumferential direction of the antenna.

19. The antenna assembly of claim 17, wherein a width of a part of the second stacked dielectric layer exposed to the upper side between the second peripheral conductive layer and the second stacked conductive layer is between 0.10 times and 0.22 times a free space wavelength of the antenna.

20. An antenna assembly comprising: a base plate; a multi-layer insulating structure stacked on an upper side of the base plate and comprising an opening formed therethrough in a thickness direction thereof; and an antenna disposed on the base plate such that the antenna is positioned inside the opening, wherein the multi-layer insulating structure comprises: a plurality of stacked dielectric layers and a plurality of stacked conductive layers that are alternately arranged; and a first peripheral conductive layer disposed along at least a portion of an inner circumferential surface of the opening, wherein the multi-layer insulating structure is configured to tilt a radiation direction of the antenna.
